(19) United States
(12) Patent Application Publication
(10) Pub. No.: US 2006/0194129 A1
(43) Pub. Date: Aug. 31, 2006

(54) Substrate edge focus compensation

(76) Inventors: Douglas M. Horn, Portland, OR (US); Brent P. Gwynn, Portland, OR (US); Kirk A. Rolofson, Gresham, OR (US)

Correspondence Address: LSI LOGIC CORPORATION, 1621 BARBER LANE, MS: D-106, MILPITAS, CA, 95035, US

(21) Appl. No.: 11/065,856

(22) Filed: Feb. 25, 2005

(51) Int. Cl. G03C 5/00

(52) U.S. Cl. 430/30

(57) ABSTRACT

A method for compensating a focus of an exposure field of view in an exposure tool. A height at a plurality of positions is measured across a substrate at a given layer using a tool other than the exposure tool. Edge positions on the substrate are identified where the height varies significantly from the height in center portions of the substrate. A focus compensation value is developed for the identified edge positions, and the identified edge positions are correlated with exposure fields of view on the exposure tool. The focus compensation value is input in an exposure program for use when the exposure tool focuses on the exposure fields of view that correlate with the identified edge positions. The method is repeated for as many layers of the substrate as desired.

### FIELD

This invention relates to the field of integrated circuit fabrication. More particularly, this invention relates to improving the focus of design patterns that are projected onto a substrate during photolithographic operations.

### BACKGROUND

In very simple terms, integrated circuits are fabricated by depositing a layer on a substrate, patterning and processing the layer using one or more of a variety of different methods, and then repeatedly forming additional layers on top. As the term is used herein, “integrated circuit” includes devices such as those formed on monolithic semiconducting substrates, such as those formed of group IV materials like silicon or germanium, or group III-V compounds like gallium arsenide, or mixtures of such materials. The term includes all types of devices formed, such as memory and logic, and all designs of such devices, such as MOS and bipolar. The term also comprehends applications such as flat panel displays, solar cells, and charge coupled devices.

As a part of this process, photoresist is often applied as a part of patterning a given layer. An image from a mask or reticle is projected onto the photoresist, which is exposed by the light passing through the mask. The exposed portions of the photoresist undergo a chemical change that causes them to either remain or be washed away in a developing process, as desired. This pattern in the photoresist is then transferred to either an underlying or a subsequently overlying layer.

The masks typically contain the patterns needed for a relatively small number of integrated circuits, which are exposed in a first part of the substrate, and then repeatedly stepped across the surface of the substrate until the entire substrate has been exposed with the patterns on the mask. It is extremely important that the pattern projected onto the photoresist is in a desired focus at a desire plane of the photoresist for each exposure across the substrate, or else the image will not be properly formed, and the integrity of the integrated circuits may be compromised.

Because the layers formed on the substrate during the fabrication of the integrated circuits tend to have variations in their height, many different methods and systems have been developed to help ensure that a proper focus is achieved for each exposure across the substrate. One of these methods is an autofocus of the optics that are used to expose the pattern.

Unfortunately, autofocus methods tend to rely on an assumption that the height of a layer within a given exposure field is all about the same. Although several measurements may be taken within the field in order to set the focus, some type of average of the measurements is finally used for the focus. If there is a large degree of height variation within the measured field, then the focus specified by the autofocus system may not be correct for any of the actual layer heights within the field of exposure.

This problem tends to be particularly prevalent at the edge of the substrates, and even more so after a polishing process. When a substrate is polished, the upper most layer is substantially planarized, which tends to remove most height variations in the layer, except at the very edges, where the height of the layer may rise dramatically. Autofocus under various conditions tends to produce very poor results in these edge areas of the substrate.

What is needed, therefore, is a system whereby problems such as those described above are overcome, at least in part.

### SUMMARY

The above and other needs are met by a method for compensating a focus of an exposure field of view in an exposure tool. A height at a plurality of positions is measured across a substrate at a given layer using a tool other than the exposure tool. Edge positions on the substrate are identified where the height varies significantly from the height in center portions of the substrate. A focus compensation value is developed for the identified edge positions, and the identified edge positions are correlated with exposure fields of view on the exposure tool. The focus compensation value is input in an exposure program for use when the exposure tool focuses on the exposure fields of view that correlate with the identified edge positions. The method is repeated for as many layers of the substrate as desired.

According to another aspect of the invention there is described a software program for focusing an exposure field of view on a layer of a substrate in an exposure tool, that uses a previously measured height for the exposure field of view to adjust the focus for the exposure field of view, where the previously measured height was measured on a tool other than the exposure tool.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a representation of exposure fields of view across the surface of a substrate of integrated circuits, depicting an example of zones where focus compensation can be applied according to a preferred embodiment of the present invention.

FIG. 2 is a flow chart of the method for applying focus compensation to certain exposure fields of view on a substrate according to a preferred embodiment of the present invention.

### DETAILED DESCRIPTION

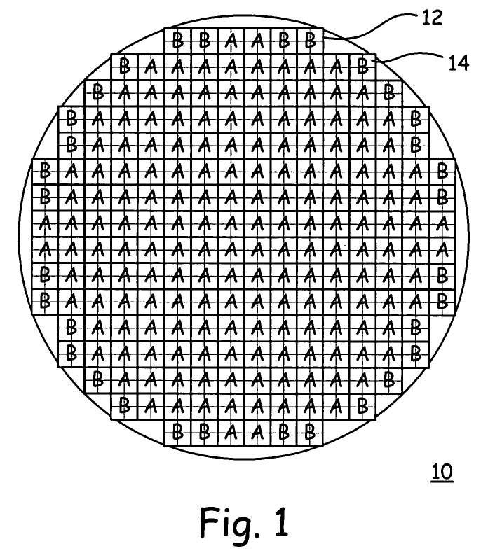

FIG. 1 depicts a map of a substrate 10, having a plurality of integrated circuit patterns 14 disposed thereon. The integrated circuit patterns are disposed in exposure fields of view 12 that include four integrated circuit patterns 14 each. It is appreciated that the number and size of the integrated circuit patterns 14 on the substrate 10 is representational only, as is the number of integrated circuit patterns 14 within the field of view 12, and that other examples could have been selected to describe the various embodiments of the present invention.

The fields of view 12 are labeled in FIG. 1 as either A or B. The A fields 12 represent those fields 12 that all have a height that is within a given tolerance of a standard height, or in other words represent portions of the substrate 10 that are relatively planar. For these portions A of the substrate 10, no focus compensation as described herein tends to be required, because these portions do not vary significantly in height, and thus averaged autofocus methods tend to work well with them.

However, those portions of the substrate 10 that are labeled as B are areas where the height of the substrate 10 tends to vary dramatically, and thus an averaged autofocus of the substrate 10 does not work well. For example, the thickness of one or more of the layers may vary dramatically within these areas B, or the autofocusing systems of the exposure tool may take height readings that are off the edge of the substrate 10, either of which tends to produce an average height reading for the autofocus that does not work well for exposing the field of view B.

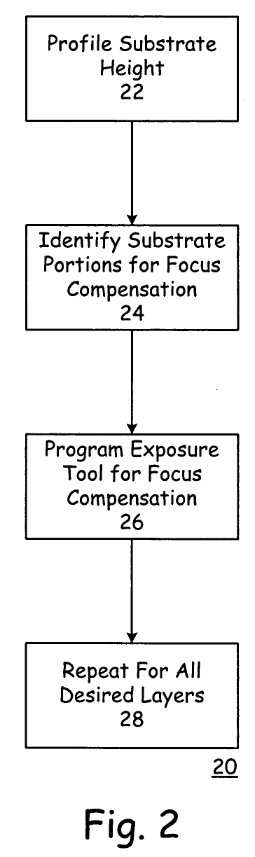

Thus, according to preferred embodiment of the invention, in those portions A of the substrate 10 a normal focusing routine is used by the exposure tool, while in those portions B of the substrate 10, a compensated focusing routine is preferably used. This compensated routine preferably uses a height value that is developed in a manner described in reference to FIG. 2, and does not use an autofocus based on height measurements taken by the exposure tool.

According to the method 20 as depicted in FIG. 2, the height of the substrate 10 after the formation of a given layer is profiled, meaning that many different height measurements are made across the surface of the substrate 10, such as in a grid or other pattern, as given in block 22. This information is then analyzed to identify those portions A of the substrate 10 for which focus compensation is not really needed, and those portions B of the substrate 10 in which focus compensation can be of some benefit, as given in block 24.

The height information for those portions B of the substrate 10 is then programmed into the exposure tool for use in focusing the exposure tool in those portions B on the layer that has been measured, as given in block 26. Preferably, these height measurements are used in place of an autofocus routine, which tends to produce erroneous results, as described above. In this manner, an actual measurement value for the layer, as produced on a tool other than the exposure tool, is used to set the focus for the exposure tool. This process is then repeated for all layers that exhibit such problems, as given in block 28.

Most preferably, the measurements on the separate tool are not taken for each individual substrate 10, but instead such measurements are taken on a sampling of the substrates 10 to develop a profile that can be used for the substrates 10 at that point in the process. The quality of the focus can be checked after exposure or processing of the substrate 10, to ensure that the height value provided for the layer in those portions B is producing a proper focus.

In alternate embodiments of the invention, more than one compensation value can be applied to more than one portion of the substrate 10. For example, there may still be a large portion of the substrate 10 that is identified as fields A, where autofocus works just fine. However, instead of just a single portion B, there may be portions B, C, and D, etc., where different focus compensation values are used for each portion instead of the autofocus routine of the exposure tool.

In this manner, a better focus is provided for the fields of view B at the edges of the substrate 10, and a greater yield of those integrated circuits 14 at those positions may be enabled.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for compensating a focus of an exposure field of view in an exposure tool, the method comprising the steps of:
measure a height at a plurality of positions across a substrate at a given layer using a tool other than the exposure tool,
identify edge positions on the substrate where the height varies significantly from the height in center portions of the substrate,
develop a focus compensation value for the identified edge positions,
correlate the identified edge positions with exposure fields of view on the exposure tool,
input the focus compensation value in an exposure program for use when the exposure tool focuses on the exposure fields of view that correlate with the identified edge positions, and
repeat the method for as many layers of the substrate as desired.

2. In a software program for focusing an exposure field of view on a layer of a substrate in an exposure tool, the improvement comprising using a previously measured height for the exposure field of view to adjust the focus for the exposure field of view, where the previously measured height was measured on a tool other than the exposure tool.
